(19) United States
(12) Patent Application Publication
(10) Pub. No.: US 2024/0219332 A1
(43) Pub. Date: Jul. 4, 2024

(54) ELECTRICAL IMPEDANCE IMAGING SENSING ELEMENT, SENSING SYSTEM AND SENSING METHOD THEREOF

(71) Applicant: INDUSTRIAL TECHNOLOGY RESEARCH INSTITUTE, Hsinchu (TW)

(72) Inventors: Chang-Lin HU, Kaohsiung City (TW); Zong-Yan LIN, Taipei City (TW); I-Cheng CHENG, New Taipei City (TW); Chien-Ju LI, Zhubei City (TW); Chii-Wann LIN, Taipei City (TW)

(73) Assignee: INDUSTRIAL TECHNOLOGY RESEARCH INSTITUTE, Hsinchu (TW)

(21) Appl. No.: 18/536,860

(22) Filed: Dec. 12, 2023

Related U.S. Application Data
(60) Provisional application No. 63/435,577, filed on Dec. 28, 2022.

(30) Foreign Application Priority Data
Aug. 31, 2023 (TW) 112133093

(51) Int. Cl. G01N 27/02

(52) U.S. Cl. CPC G01N 27/02

(57) ABSTRACT

An electrical impedance imaging sensing system includes a signal processing device, a sensing element and a processor. The signal processing device is electrically coupled to the sensing element and configured for outputting an emission signal. Each of N electrodes of the sensing element is configured to receive a received signal after the emission signal passes through a to-be tested object. The processor is configured to determine whether one of the N electrodes fails according to a plurality of the received signal; in response to the failure of the electrode, compensate the received signal of the failed electrode; and generate an electrical impedance image pre-processing data according to the received signal.

This application claims the benefit of U.S. Provisional application Ser. No. 63/435,577, filed Dec. 28, 2022, and Taiwan application Serial No. 112133093, filed Aug. 31, 2023, the subject matters of which are incorporated herein by references.

### FIELD OF THE INVENTION

The invention relates to an electrical impedance imaging sensing element, a sensing system and a sensing method thereof.

### BACKGROUND OF THE INVENTION

Electrical Impedance Tomography (EIT) is a radiation-free, real-time, low-cost imaging technology, and these advantages enable the continuous development of this technology in academic research. However, if any electrode of the EIT sensing device fails, it may result in somewhat distortion of the image. Therefore, how to improve the aforementioned issue is one of the goals of those in this technical field.

### SUMMARY OF THE INVENTION

In an embodiment of the invention, an electrical impedance imaging sensing element is provided. The electrical impedance imaging sensing element includes a body and N electrodes. The body has a plurality of openings. Each of the N electrodes is embedded in the body and partially exposed from the corresponding opening. Each of the N electrodes is braided by a plurality of conductive wires, and N is a positive integer greater than or equal to 1.

In another embodiment of the invention, an electrical impedance imaging sensing system is provided. The electrical impedance imaging sensing system includes a signal processing device, the sensing element as described above and a processor. The signal processing device is electrically coupled to the sensing element and configured to output an emission signal. Each of the N electrodes is configured to receive a received signal of the emission which passes through a to-be-measured body. The processor is configured to: determine whether a determined one of the N electrodes has failed according to a plurality of the received signal; in response to failure of the determined one of the N electrodes, compensate for the received signal of a failed electrode of the N electrodes; and generate an electrical impedance image pre-processing data according to a plurality of the received signal.

In another embodiment of the invention, an electrical impedance imaging sensing method includes the following steps: outputting an emission signal to the sensing element as described above by the signal processing device; receiving a received signal of the emission signal which passes through the to-be-measured body by each of the N electrodes of the sensing element; determining whether a determination one of the N electrodes has failed according to a plurality of the received signal by a processor; in response to failure of the determined one of the N electrodes, compensating for the received signal of a failed electrode of the N electrodes; and generating an electrical impedance image pre-processing data according to the a plurality of the received signal by the processor.

Numerous objects, features and advantages of the invention will be readily apparent upon a reading of the following detailed description of embodiments of the invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the invention will become more readily apparent to those ordinarily skilled in the art after reviewing the following detailed description and accompanying drawings, in which:

FIG. 1 illustrates a schematic diagram of the electrical impedance imaging sensing system according to an embodiment of the present disclosure;

FIGS. 2A to 2B illustrate schematic diagrams of an electrical impedance imaging sensing element in FIG. 1 in different perspectives;

FIG. 3 illustrates a flow chart of a sensing method according to an embodiment of the electrical impedance imaging sensing system in FIG. 1;

FIG. 4 illustrates a flow chart of a sensing method of another embodiment of the electrical impedance imaging sensing system in FIG. 1;

FIG. 5A illustrates a schematic diagram of a relationship between the received signal received by the electrodes of the electrical impedance imaging sensing element and the receiving orders;

FIG. 5B illustrates a schematic diagram of a relationship between the compensated received signal and the receiving orders in FIG. 5A;

FIG. 6A illustrates a schematic diagram of the simulated image diagram corresponding to the received signal (before compensation) in FIG. 5A;

FIG. 6B illustrates a schematic diagram of the simulated image corresponding to the received signal (after compensation) in FIG. 5B;

FIG. 7 illustrates a flow chart of the sensing method of another embodiment of the electrical impedance imaging sensing system in FIG. 1;

FIG. 8A illustrates a schematic signal diagram of the received signal of the (f+1)^{th} received signal group in FIG. 5A after shifted;

FIG. 8B illustrates a schematic signal diagram of the received signal S₁ to S₁₆ of the (f−2)^{th} received signal group G_{f-2} after shifted;

FIG. 9 illustrates a schematic signal diagram of the f^{th} received signal group in FIG. 5A replaced by the shifted (f+1)^{th} received signal group in FIG. 8A and the (f−1)^{th} received signal group in FIG. 5A replaced by the shifted (f−2)^{th} received signal group in FIG. 8B.

### DETAILED DESCRIPTION OF PREFERRED EMBODIMENTS

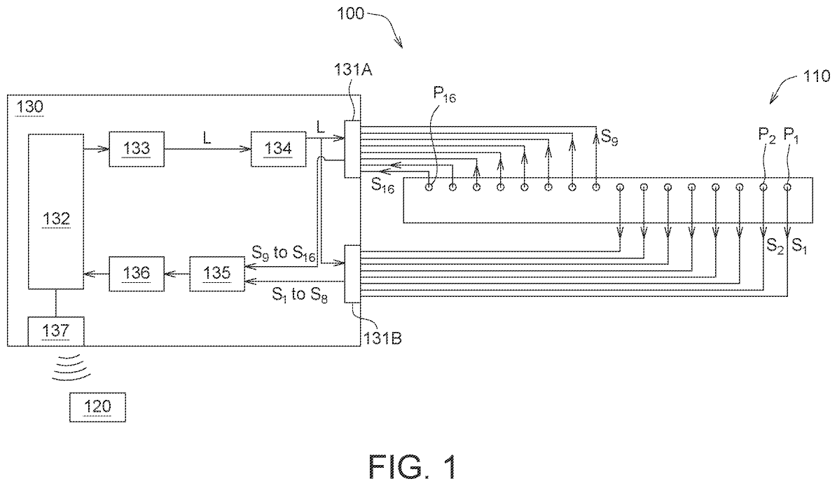

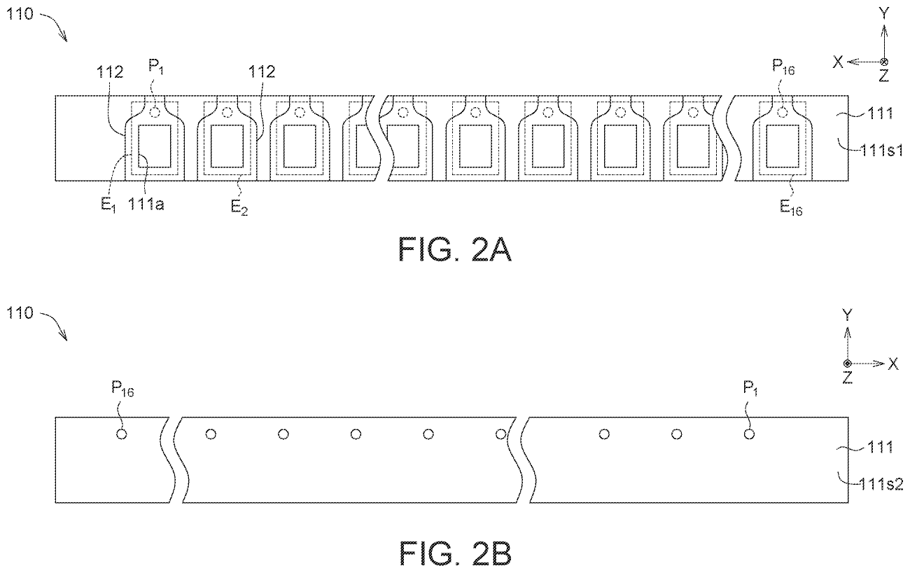

Referring to FIGS. 1 to 2B, FIG. 1 illustrates a schematic diagram of the electrical impedance imaging sensing system 100 according to an embodiment of the present disclosure, and FIGS. 2A to 2B illustrate schematic diagrams of an electrical impedance imaging sensing element 110 in FIG. 1 in different perspectives.

As illustrated in FIG. 1, the electrical impedance imaging sensing system 100 includes the electrical impedance imaging sensing element 110, a processor 120 and a signal processing device 130. The electrical impedance imaging sensing system 100 is, for example, a portable EIT sensing system. The processor 120 is, for example, a physical circuit formed by a semiconductor process, such as an integrated circuit, such as a chip, a bare die, or a semiconductor package.

As illustrated in FIGS. 2A and 2B, the electrical impedance imaging sensing element 110 is, for example, an EIT sensor. The electrical impedance imaging sensing element 110 includes a body 111, N electrodes (e.g., electrodes E₁ to E₁₆), N electrode fasteners (e.g., electrode fasteners P₁ to P₁₆), and N adhesive tapes 112. The body 111 has N openings 111a. N is a positive integer greater than or equal to 1. Each electrode is embedded in the body 111 and partially exposed from the corresponding opening 111a. Each electrode is, for example, braided by a plurality of conductive threads. As a result, the resistances of the electrodes E₁ to E₁₆ in the embodiment of the present invention are very small, which may provide excellent signal transmission quality.

In the present embodiment, the value of N is, for example, 16, but it may also be more or less.

As illustrated in FIGS. 2A and 2B, the body 111 is in a strip shape. In use, the electrical impedance imaging sensing element 110 may surround a to-be-measured body (e.g., a part corresponding to the lungs) of the to-be-measured body (e.g., a human body). The signal processing device 130 may emit an emission signal L to the electrical impedance imaging sensing element 110. The emission signal L is emitted from the electrode of the electrical impedance imaging sensing element 110 into the to-be-measured body, becomes a plurality of received signal S₁ to S₁₆ after passing through a tissue (for example, lung) in the to-be-measured body, and received by all electrodes E₁ to E₁₆. Tissue may contain air, which forms the impedance of the tissue. The emission signal L changes its electrical properties after passing through the impedance. The values of the received signal S₁ to S₁₆ received by the electrodes E₁ to E₁₆ depend on an impedance distribution (change) of the tissue in the to-be-measured body. The processor 120 may establish a corresponding tissue image according to the received signal S₁ to S₁₆.

As illustrated in FIGS. 2A and 2B, the body 111 is formed of nylon material, for example. The body 111 covers 16 (i.e., N) electrodes E₁ to E₁₆ and the electrode fasteners P₁ to P₁₆. The body 111 has a first surface 111s1 and a second surface 111s2 opposite to the first surface 111s1. Each opening 111a is formed on the first surface 111s1 and exposes a portion of the corresponding electrode, wherein the exposed electrode may directly or indirectly contact the to-be-measured body. The electrode fasteners P₁ to P₁₆ are exposed from the second surface 111s2 and are electrically connected to the processor 130 (the processor 130 is illustrated in FIG. 1). The adhesive tape 112 may be disposed on the first surface 111s1 of the body 111 and expose corresponding electrode. The adhesive tape 112 may combine the electrode with the body 111 so that the electrode and the body 111 are tightly bonded together.

In an embodiment, each electrode is, for example, a textile electrode. For example, the electrodes E₁ to E₁₆ each include a plurality of fibers and conductive threads, wherein the fibers may encapsulate the conductive threads. The fiber is a textile thread that has the advantages of soft, washable, thin, and resistant to folding, so it will not cause discomfort when attached to the human body. The conductive wire is formed of a material including, for example, gold, silver, copper or other materials with excellent conductivity. In comparison with the conventional electrocardiogramatch which has a high resistance of about 2 ohms, the electrode according to the embodiment of the present invention has a low resistance of 0.2 ohms, thereby providing better signal transmission quality.

As illustrated in FIGS. 1, 2A and 2B, each of the electrode fasteners P₁ to P₁₆ may be electrically connected to the corresponding electrode to transmit the received signal S₁ to S₁₆ received by the electrodes E₁ to E₁₆ to the processor 130, for example, through the signal processing device 130.

As illustrated in FIG. 1, each electrode of the electrical impedance imaging sensing element 110 is configured to receive the received signal. For example, the electrode E₁ receives the received signal S₁, the electrode E₂ receives the received signal S₂, the electrode E₃ receives the received signal S₃, the electrode E₄ receives the received signal S₄, the electrode E₅ receives the received signal S₅, the electrode E₆ receives the received signal S₆, the electrode E₇ receives the received signal S₇, the electrode E₈ receives the received signal S₈, the electrode E₉ receives the received signal S₉, the electrode E₁₀ receives the received signal S₁₀, the electrode E₁₁ receives the received signal S₁₁, the electrode E₁₂ receives the received signal S₁₂, the electrode E₁₃ receives the received signal S₁₃, the electrode E₁₄ receives the received signal S₁₄, the electrode E₁₅ receives the received signal S₁₅, and the electrode E₁₆ receives the received signal S₁₆. The processor 130 is electrically coupled to the electrical impedance imaging sensing element 110 and is configured to: determine whether one (or a determination one) of the electrodes E₁ to E₁₆ has failed according to the received signal S₁ to S₁₆; and in response to failure of one of the electrodes E₁ to E₁₆, compensates for the received signal of the failed electrode. As a result, the distortion of the tissue image established by the processor 120 according to the compensated received signal is greatly reduced and is close to a correct tissue image.

As illustrated in FIG. 1, the signal processing device 130 includes a first connector 131A, a second connector 131B, a processing chip 132, a signal generator 133, a switch 134, a differential amplifier 135, an analog-to-digital converter (ADC) 136 and a wireless communication unit 137. The first connector 131A, the second connector 131B, the processing chip 132, the signal generator 133, the switch 134, the differential amplifier 135, the analog-to-digital converter 136 and/or the wireless communication unit 137 may be a physical circuit formed by, for example, a semiconductor process, wherein the physical circuit is, for example, an integrated circuit such as a chip, die, or semiconductor package.

As illustrated in FIG. 1, the first connector 131A and the second connector 131B are, for example, D-sub (D-subminiature). The first connector 131A and the second connector 131B may electrically connect the electrodes E₁ to E₁₆ to transmit the emission signal L (e.g., current signal) to a corresponding electrode and receive the received signal S₁ to S₁₆ from all the electrodes E₁ to E₁₆ at one time. The processing chip 132 is, for example, an SoC chip (e.g., FPGA Z7000 SoC), which may control the signal generator 133 to generate the t emission signal L, and transmit the signal converted by the analog-to-digital converter 136 to the wireless communication unit 137. The processing chip 132 may control the frequency, intensity, etc. of the emission signal L to obtain different sensing modes. The switch 134 is, for example, a data selector (multiplexer, MUX). The switch 134 has 16 (i.e., N) channels, and may turn on one of the channels in turn to transmit the emission signal L to a corresponding electrode. The differential amplifier 135 is configured to perform differential operations on the received signal S₁ to S₁₆. The analog-to-digital converter 136 may convert the received signal S₁ to S₁₆ (e.g., voltage signal) into digital signal. The wireless communication unit 137 may transmit digital signal to the processor 130 using wireless communication technology (e.g., Wi-Fy), and the processor 130 performs calculations.

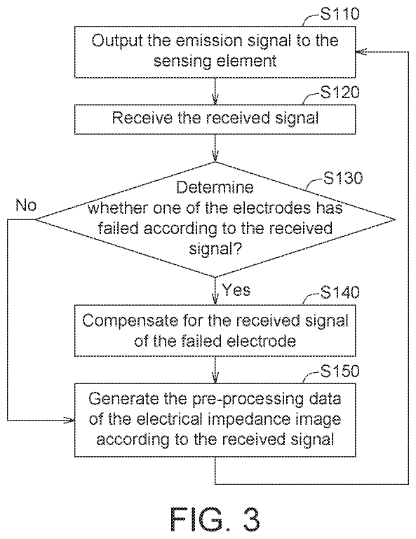

Referring to FIG. 3, FIG. 3 illustrates a flow chart of a sensing method according to an embodiment of the electrical impedance imaging sensing system 100 in FIG. 1.

In step S110, the signal processing device 130 outputs the emission signal L to the electrical impedance imaging sensing element 110. The emission signal L is emitted from one of the 16 electrodes of the electrical impedance imaging sensing element 110 into the to-be-measured body, and the emission signal L changes tissue's electrical properties after passing through the tissue in the to-be-measured body.

In step S120, the electrodes E₁ to E₁₆ of the electrical impedance imaging sensing element 110 receive the received signal S₁ to S₁₆ respectively.

In step S130, the processor 120 determines whether one of the electrodes E₁ to E₁₆ has failed according to the received signal S₁ to S₁₆. If yes, the process proceeds to step S140; if not, the process proceeds to step S150.

In step S140, the processor 120 compensates the received signal of the failed electrode.

In step S150, the processor 120 generate, using appropriate or known electrical impedance imaging technology, a set of electrical impedance image pre-processing data according to the received signal S₁ to S₁₆ (compensated received signal or uncompensated received signal). The processor 120 may generate a simulated image according to the electrical impedance image pre-processing data. The disclosed embodiment does not limit the type of electrical impedance image pre-processing data. As long as data can be used to generate simulated image, such data can be used as the electrical impedance image pre-processing data in the disclosed embodiment.

Then, the process returns to step S110 to generate the next simulated image.

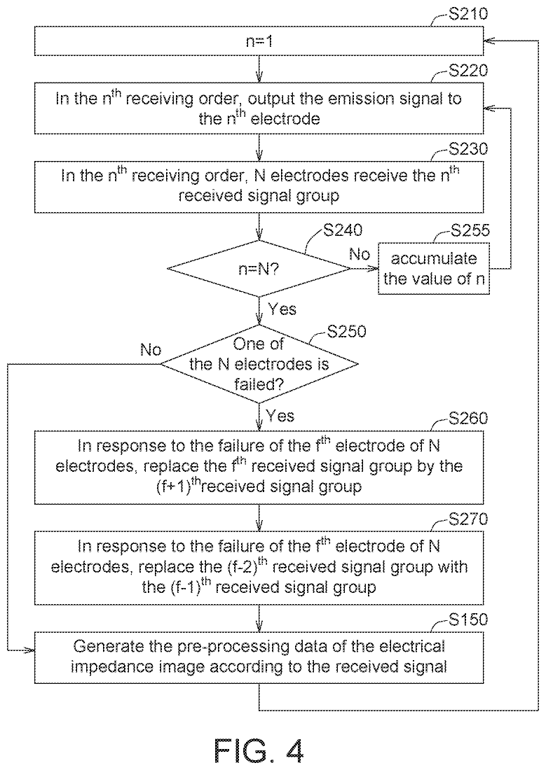

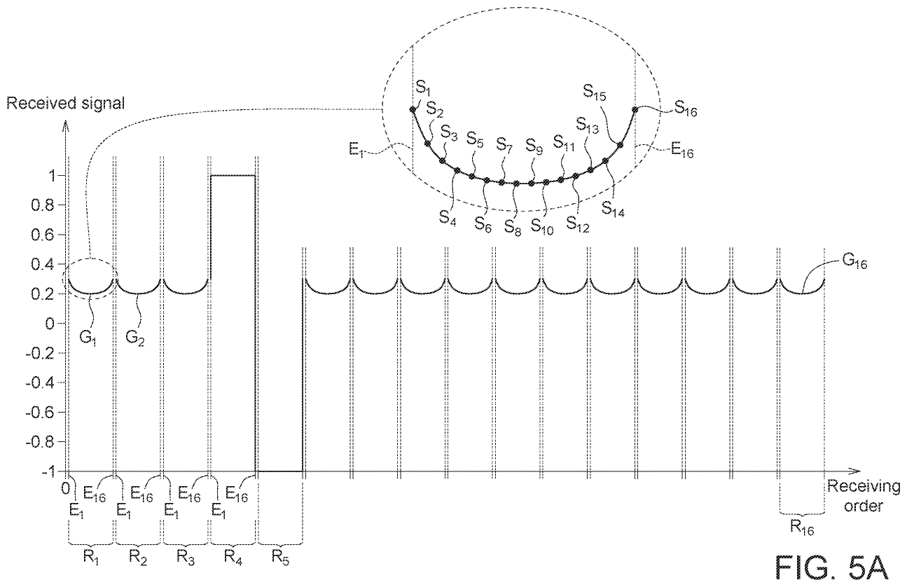

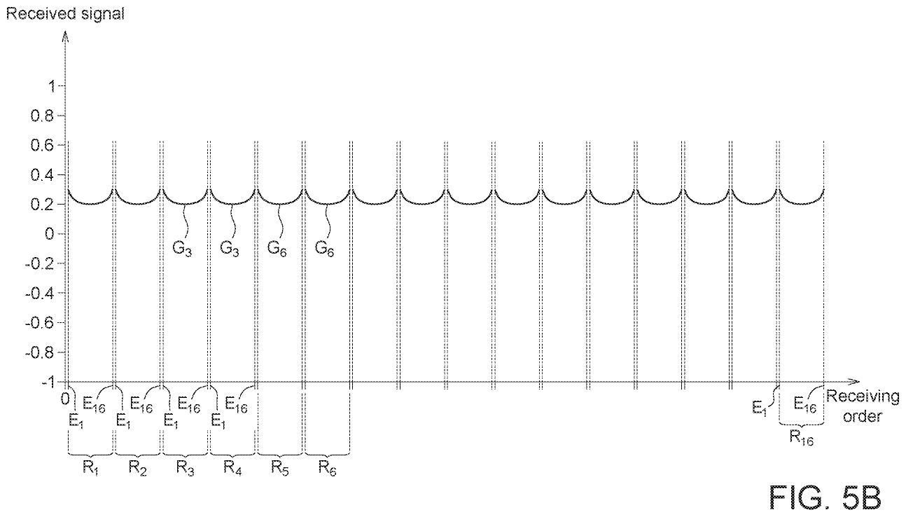

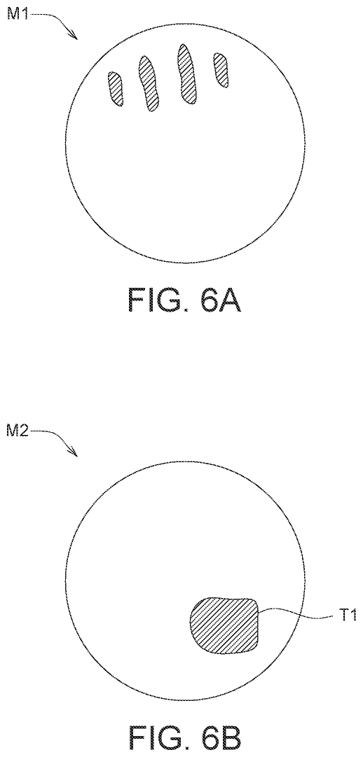

Referring to FIGS. 4, 5A to 5B and 6A to 6B, FIG. 4 illustrates a flow chart of a sensing method of another embodiment of the electrical impedance imaging sensing system 100 in FIG. 1, FIG. 5A illustrates a schematic diagram of a relationship between the received signal S₁ to S₁₆ received by the electrodes E₁ to E₁₆ of the electrical impedance imaging sensing element 110 and the receiving orders Rₙ, FIG. 5B illustrates a schematic diagram of a relationship between the compensated received signal S₁ to S₁₆ and the receiving orders Rₙ in FIG. 5A, FIG. 6A illustrates a schematic diagram of the simulated image diagram corresponding to the received signal (before compensation) in FIG. 5A, and FIG. 6B illustrates a schematic diagram of the simulated image corresponding to the received signal (after compensation) in FIG. 5B.

In step S210, the processing chip 132 of the signal processing device 130 sets the initial value of n to 1.

In step S220, as illustrated in FIG. 1, in the n^{th} receiving order Rₙ, the signal processing device 130 outputs the emission signal L to the n^{th} electrode Eₙ, where n ranges between 1 to 16 (that is, 1 to N) between positive integers. The n^{th} electrode Eₙ emits the emission signal L into the to-be-measured body, so it may be called the “emitting electrode”. In an embodiment, the emission signal L is, for example, a current. In addition, in the n^{th} receiving order Rₙ, the processing chip 132 may set the (n−1)^{th} electrode Eₙ₋₁ as the “grounding electrode”.

In step S230, as illustrated in FIG. 5A, in the n^{th} receiving order Rₙ, in response to the emission signal L, the electrodes Et to E₁₆ receive an n^{th} received signal group Gₙ, where the n^{th} received signal group Gₙ includes, in the receiving order Rₙ, the received signal S₁ to S₁₆ received by the electrodes E₁ to E₁₆.

In step S240, the processing chip 132 determines whether the value of n is equal to 16 (i.e., N). If yes, it means that a sensing cycle has been completed, and the process proceeds to step S250 to start to determine whether there is a failed electrode; if not, it means that the sensing cycle has not been completed, and the process proceeds to step S255, and the processor 120 accumulates the value of n, that is, n=n+1, and then the process returns to step S220.

To sum up, as illustrated in FIG. 5A, 16 electrodes E₁ to E₁₆ take turns as emitting electrode, and a total of 16 receiving orders R₁ to R₁₆ is obtained. The 16 receiving orders R₁ to R₁₆ are defined as one sensing cycle. The processor 20 may analyze the received signal in one sensing cycle to obtain the tissue image. In one receiving order Rₙ, the electrodes E₁ to E₁₆ may receive a group of received signal Gₙ. After N electrodes take turns as emitting electrodes, a total of N received signal groups may be received, that is, N×N received signal. For example, in case of N being equal to 16, after the 16 electrodes E₁ to E₁₆ take turns as emitting electrodes, a total of 16 received signal groups G₁ to G₁₆ may be received. One received signal group includes 16 (i.e., N) received signal S₁ to S₁₆, so the 16 received signal groups G₁ to G₁₆ includes a total of 16×16 received signal. If one of the electrodes E₁ to E₁₆ fails (for example, falls off, malfunctions, or is unable to emit signal due to other reason), the tissue image will be severely distorted. For example, as illustrated in FIG. 6A, if one of the electrodes E₁ to E₁₆ fails, the simulated image M1 established with the signal diagram illustrated in FIG. 5A cannot correctly represent the simulated impedance T1 in the tissue (the impedance T1 is illustrated in FIG. 6B).

In step S250, the processor 120 determines whether one of the electrodes E₁ to E₁₆ is failed according to the received signal groups G₁ to G₁₆. If yes, the process proceeds to step S260; if not, the process proceeds to step S150.

In step S260, in response to the failure of the f^{th} one of the electrodes E₁ to E₁₆ (the electrode E_{f}), the processor 120 replaces the f^{th} received signal group G_{f} with the (f+1)^{th} received signal group G_{f+1}. The value of f is one of 1 to 16 (i.e., 1 to N). The actual value of f depends on the coding number of the failed electrode. Taking the 5^{th} electrode E₅ as the failed electrode (the received signal group G₅ in FIG. 5A is abnormal) for an example, as illustrated in FIG. 5B, the processor 120 replaces the 5^{th} received signal group G₅ with the 6^{th} received signal group G₆. For example, the processor 120 replaces the received signal S₁ to S₁₆ of the 5^{th} received signal group G₅ with the received signal S₁ to S₁₆ of the 6^{th} received signal group G₆ respectively.

In step S270, in response to the failure of the f^{th} electrode E_{f} of the electrodes E₁ to E₁₆, the processor 120 replaces the (f−1)^{th} received signal group G_{f-1} with the (f−2)^{th} received signal group G_{f-2}. Furthermore, due to the received signal group G_{f-1} and the received signal group G_{f} performing a differential operation, an abnormal received signal group Gf will cause the received signal group G_{f-1} to be abnormal. Taking the 5^{th} electrode E₅ as the failed electrode (the received signal group G₅ in FIG. 5A is abnormal) for an example, in the 4^{th} receiving order R₄, the 4^{th} electrode E₄ serves as the emitting electrode. Due to the received signal S₁ to S₁₆ of the received signal group G₄ and the received signal S₁ to S₁₆ of the received signal group G₅ performing the difference operation, the received signal group G₄ will also be abnormal due to the abnormality of the received signal group G₅. As illustrated in FIG. 5B, the processor 120 replaces the 4^{th} received signal group G₄ with the 3^{th} received signal group G₃ to eliminate the abnormality of the received signal group G₄ in FIG. 5A. Furthermore, the processor 120 replaces the received signal S₁ to S₁₆ of the 4^{th} received signal group G₄ with the received signal S₁ to S₁₆ of the 3^{th} received signal group G₃ respectively. As a result, as illustrated in FIG. 6B, the compensated simulated image M2 established with the compensated signal diagram illustrated in FIG. 5B may correctly image the simulated impedance T1 in the tissue.

Then, the process returns to step S210, where the processor 120 sets the value of n as the initial value and continues the next sensing cycle.

During the sensing process, unless the process is terminated manually, the process in FIG. 4 may continue in a loop (namely, repeated).

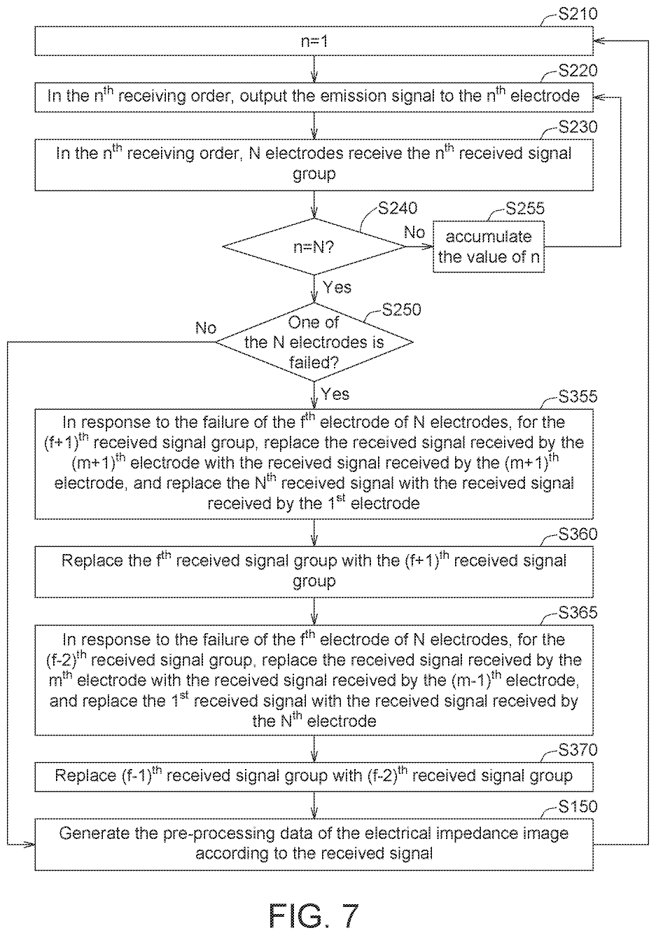

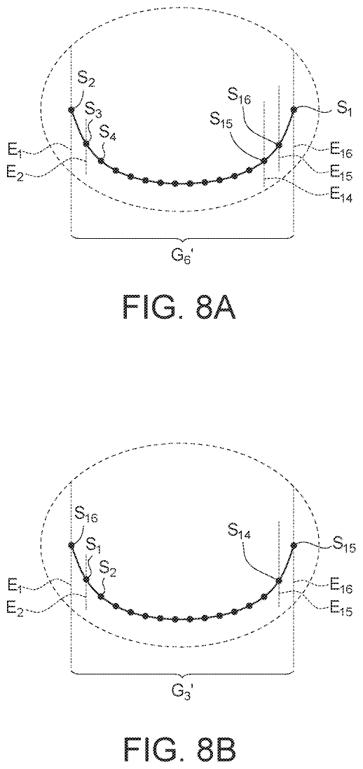

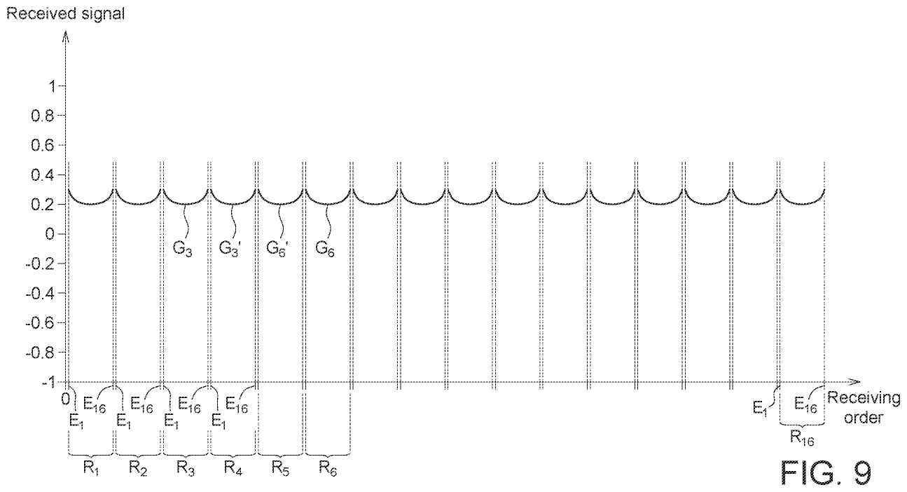

Referring to FIGS. 7 to 9, FIG. 7 illustrates a flow chart of the sensing method of another embodiment of the electrical impedance imaging sensing system 100 in FIG. 1, FIG. 8A illustrates a schematic signal diagram of the received signal S₁ to S₁₆ of the (f+1)^{th} received signal group G_{f+1} in FIG. 5A after shifted, FIG. 8B illustrates a schematic signal diagram of the received signal S₁ to S₁₆ of the (f−2)^{th} received signal group G_{f-2} after shifted, and FIG. 9 illustrates a schematic signal diagram of the f^{th} received signal group G_{f} in FIG. 5A replaced by the shifted (f+1)^{th} received signal group G′_{f+1} in FIG. 8A and the (f−1)^{th} received signal group G_{f-1} in FIG. 5A replaced by the shifted (f−2)^{th} received signal group G′_{f-2} in FIG. 8B.

Steps S150, S210 to S250 and S280 in FIG. 7 have been described above and they will not be repeated here. The description will start from step S355 below.

In step S355, in response to the failure of the f^{th} electrode (the electrode E_{f}) of the 16 electrodes, for the (f+1)^{th} received signal group G_{f+1}, the processor 120 replaces the received signal Sₘ received by the m^{th} electrode Eₘ with the received signal Sₘ₊₁ received by the (m+1)^{th} electrode Eₘ₊₁ before shifted (as illustrated in FIG. 5A), and replaces the received signal S_{N} received by the N^{th} electrode E_{N} with the received signal S₁ received by the 1^{th} electrode E₁ before shifted (as illustrated in FIG. 5A). In other words, for the (f+1)^{th} received signal group G_{f+1}, the processor 120 replaces the received signal Sₘ₊₁ received, before the electrode Eₘ₊₁ is shifted, is shifted backward (by previous electrode) with the received signal Sₘ of the electrode Eₘ. After the shifted, the received signal Sₘ of each electrode Eₘ is the received signal Sₘ₊₁ of the next electrode Eₘ₊₁ before shifted. The aforementioned m is, for example, a positive integer ranging between 1 and N.

Taking the 5^{th} electrode E₅ as the failed electrode (the received signal group G₅ in FIG. 5A is abnormal) for an example, as illustrated in FIG. 8A, for the 6^{th} received signal group G₆, the processor 120 replaces the received signal S₂, before shifted, received by the electrode E₂ with the received signal S₁ received by the electrode E₁, replaces the received signal S₃, before shifted, received by the electrode E₃ with the received signal S₂ received by the electrode E₂, replaces the received signal S₄, before shifted, received by the electrode E₄ with the received signal S₃ received by the electrode E₃, replaces the received signal S₅, before shifted, received by the electrode E₅ with the received signal S₄ received by the electrode E₄, replaces the received signal S₆, before shifted, received by the electrode E₆ with the received signal S₅ received by the electrode E₅, replaces the received signal S₇, before shifted, received by the electrode E₇ with the received signal S₆ received by the electrode E₆, replaces the received signal S₈, before shifted, received by the electrode E₈ with the received signal S₇ received by the electrode E₇, replaces the received signal S₉, before shifted, received by the electrode E₉ with the received signal S₈ received by the electrode E₈, replaces the received signal S₁₀, before shifted, received by the electrode E₁₀ with the received signal S₉ received by the electrode E₉, replaces the received signal S₁₁, before shifted, received by the electrode E₁₁ with the received signal S₁₀ received by the electrode E₁₀, replaces the received signal S₁₂, before shifted, received by the electrode E₁₂ with the received signal Su received by the electrode E₁₁, replaces the received signal S₁₃, before shifted, received by the electrode E₁₃ with the received signal S₁₂ received by the electrode E₁₂, replaces the received signal S₁₄, before shifted, received by the electrode E₁₄ with the received signal S₁₃ received by the electrode E₁₃, replaces the received signal S₁₅, before shifted, received by the electrode E₁₅ with the received signal S₁₄ received by the electrode E₁₄, and replaces the received signal S₁₆, before shifted, received by the electrode E₁₆ with the received signal S₁₅ received by the electrode E₁₅. As illustrated in FIG. 8A, the 6^{th} received signal group after shifted is represented by G′₆.

The aforementioned shift processing is for the received signal S₁ to S₁₆ of the 6^{th} received signal group G₆, but the shifted received signal group G′₆ does not cover (or not replace) the received signal group Ge in FIG. 5A.

In step S360, in response to the failure of the f^{th} one of the electrodes E₁ to E₁₆ (the electrode E_{f}), the processor 120 replaces the f^{th} received signal group G_{f} with the (f+1)^{th} received signal group G_{f+1} (after shifted). Taking the 5^{th} electrode E₅ as the failed electrode (the received signal group G₅ in FIG. 5A is abnormal) for an example, the processor 120 replaces the 5^{th} received signal group G₅ in FIG. 5A with the 6^{th} received signal group G′₆ in FIG. 8A, as illustrated in FIG. 9. For example, the processor 120 replaces the received signal S₁ to S₁₆ of the 5^{th} received signal group G₅ in FIG. 5A with the received signal S₁ to S₁₆ of the 6^{th} received signal group G′₆ in FIG. 8A respectively.

The received signal of the emitting electrode is generally strongest. Shifting process for the 6^{th} received signal group Ge may make the replaced 6^{th} received signal group G′₆ in the 5^{th} receiving order R₅ in FIG. 9 be more consistent with the characteristic “the received signal of the electrode E₅ serving as the emitting electrode in the 5^{th} receiving order R₅ is the strongest”. Furthermore, for the 6^{th} received signal group G′₆ after the shifted, the received signal of electrode E₅ is the received signal S₆ (in the 6^{th} receiving order Re, the received signal of the electrode E₆ serving as the emitting electrode is the strongest). Thus, after the 5^{th} received signal group G₅ in the 5^{th} receiving order R₅ in FIG. 9 is replaced by the 6^{th} received signal group G′₆, it is the same as the situation in which the electrode E₅ serves as the emitting electrode in the 5^{th} receiving order R₅.

In step S365, as illustrated in FIG. 8B, in response to the failure of the f^{th} electrode (the electrode E_{f}) of the N electrodes, for the (f−2)^{th} received signal group G_{f-2}, the processor 120 replaces the received signal Sₘ received by the (m−1)^{th} electrode Eₘ₋₁ with the received signal Sₘ₋₁ received by the (m+1)^{th} electrode Eₘ₊₁, and replaces the received signal S₁ received by the 1^{th} electrode E₁ with the received signal S_{N} received by the N^{th} electrode E_{N}. In other words, for the (f−2)^{th} received signal group G_{f-2}, the processor 120 replaces the received signal Sₘ₊₁ received with the received signal Sₘ of the electrode Eₘ which are shifted forward (to the next electrode). After shifted, the received signal Sₘ of each electrode Eₘ is the received signal Sₘ₋₁ of the previous electrode Eₘ₋₁ before shifted.

Due to the received signal group G_{f-1} and the received signal group G_{f} performing the differential operation, an abnormal received signal group G_{f} will also cause the received signal group G_{f-1} to be abnormal. The sensing method of the embodiment of the present invention may first perform shift processing on the received signal S₁ to S₁₆ of the received signal group G_{f-2}, and then compensate the received signal group G_{f-1} according to the shifted received signal group G_{f-2}.

Taking the 5^{th} electrode E₅ as the failed electrode (the received signal group G₅ in FIG. 5A is abnormal) for an example, as illustrated in FIG. 8B, for the 3^{th} received signal group G₃, the processor 120 replaces the received signal S₂ received by the electrode E₂ with the received signal S₁, before shifted, received by the electrode E₁, replaces the received signal S₃ received by the electrode E₃ with the received signal S₂, before shifted, received by the electrode E₂, replaces the received signal S₄ received by the electrode E₄ with the received signal S₃, before shifted, received by the electrode E₃, replaces the received signal S₅ received by the electrode E₅ with the received signal S₄, before shifted, received by the electrode E₄, replaces the received signal S₆ received by the electrode E₆ with the received signal S₅, before shifted, received by the electrode E₅, replaces the received signal S₇ received by the electrode E₇ with the received signal S₆, before shifted, received by the electrode E₆, replaces the received signal S₈ received by the electrode E₈ with the received signal S₇, before shifted, received by the electrode E₇, replaces the received signal S₉ received by the electrode E₉ with the received signal S₈, before shifted, received by the electrode E₈, replaces the received signal S₁₀ received by the electrode E₁₀ with the received signal S₉, before shifted, received by the electrode E₉, replaces the received signal S₁₁ received by the electrode E₁₁ with the received signal S₁₀, before shifted, received by the electrode E₁₀, replaces the received signal S₁₂ received by the electrode E₁₂ with the received signal S₁₁, before shifted, received by the electrode E₁₁, replaces the received signal S₁₃ received by the electrode E₁₃ with the received signal S₁₂, before shifted, received by the electrode E₁₂, replaces the received signal S₁₄ received by the electrode E₁₄ with the received signal S₁₃, before shifted, received by the electrode E₁₃, replaces the received signal S₁₅ received by the electrode E₁₅ with the received signal S₁₄, before shifted, received by the electrode E₁₄, replaces the received signal S₁ received by the electrode E₁ with the received signal S₁₆, before shifted, received by the electrode E₁₆. As illustrated in FIG. 8B, the 3^{th} received signal group after shifted is represented by G′₃.

The aforementioned shift processing is for the received signal S₁ to S₁₆ of the 3^{th} received signal group G₃, but the received signal group G′₃ after shifted does not cover (or not replace) the received signal group G₃ in FIG. 5A.

In step S370, in response to the failure of the f^{th} electrode E_{f} of the 16 electrodes, the processor 120 replaces the (f−1)^{th} received signal group G_{f-1} with the (f−2)^{th} received signal group G_{f-2}. Taking the 5^{th} electrode E5 as the failed electrode (the received signal group G₅ in FIG. 5A is abnormal) for an example, the processor 120 replaces the 4^{th} received signal group G₄ in FIG. 8B with the 3^{th} received signal group G′₃, as illustrated in FIG. 9. For example, the processor 120 replaces the received signal S₁ to S₁₆ of the 4^{th} received signal group G₄ in FIG. 5A with the received signal S₁ to S₁₆ of the 3^{th} received signal group G′₃ in FIG. 8B respectively.

The received signal is generally strongest at the emitting electrode. Shifting process for the 3^{th} received signal group G₃ may make the replaced 4^{th} received signal group G′₃ in the 4^{th} receiving order R₄ in FIG. 9 be more consistent with the characteristic “the received signal of the electrode E₄ serving as the emitting electrode in the 4^{th} receiving order R₄ is the strongest”. Furthermore, for the 3^{th} received signal group G′₃ after the shifted, the received signal of electrode E₄ is the received signal S₃ (in the 3^{th} receiving order R₃, the received signal S₃ of the electrode E₃ serving as the emitting electrode is the strongest). Thus, after the 4^{th} received signal group G₄ in the 4^{th} receiving order R₄ in FIG. 9 is replaced by the 3^{th} received signal group G′₃, it is the same as the situation in which the electrode E₄ serves as the emitting electrode in the 4^{th} receiving order R₄.

The aforementioned process of determining the failed electrode and the process of compensating the received signal are executed by the processor 120, but it may also be executed by the processing chip 132 of the signal processing device 130.

In summary, embodiments of the present invention propose a sensing element, a sensing system and a sensing method thereof, which may determine whether any electrode in the N electrodes has failed (called “failed electrodes”) according to a plurality of the received signal (for example, N×N) received by N electrodes. If there is a failed electrode E_{f}, the processor or the processing chip of the signal processing device is configured to: in the first compensation method, replace the f^{th} received signal group G_{f} with the (f+1)^{th} received signal group G_{f+1} and/or replace the (f−1)^{th} received signal group G_{f-1} with the (f−2)^{th} received signal group G_{f-2}. Alternatively, the processor or the processing chip of the signal processing device is configured to: in the second compensation method, first shift the received signal S₁ to S₁₆ of the (f+p1)^{th} received signal group G_{f+p1}, and then replace the received signal group G_{f} with the shifted received signal group G′_{f+p1} and/or first shift the received signal S₁ to S₁₆ of the (f−p2)^{th} received signal group G_{f-p2}, and then replace the received signal group G_{f-1} with the shifted received signal group G′_{f-p2}, wherein p1 is a positive integer equal to 1 or greater than 1, and p2 is a positive integer equal to 2 or greater than 2.

In other words, if there is the failed electrode E_{f}, the processor or the processing chip of the signal processing device may: (1). replace the received signal group G_{f} with the received signal group (for example, the received signal group G_{f+p1} in the receiving order R_{f+p1}) which is adjacent to the received signal group G_{f} in the receiving order R_{f} (in the receiving order R_{f}, the failed electrode E_{f} serves as the emitting electrode) and normal and/or replace the received signal group G_{f-1} (in the receiving order R_{f}, the electrode E_{f-1} serves as the grounding electrode) with the received signal group (for example, the received signal group G_{f-p2} in the receiving order R_{f-p2}) which is adjacent to the received signal group G_{f} in the receiving order R_{f} (the failed electrode E_{f} serves as the emitting electrode) and normal. Alternatively, the processor or the processing chip of the signal processing device may: (2). first shift the received signal group (for example, the received signal group G_{f-p2} in the receiving order R_{f-p2}) which is adjacent to the received signal group G_{f} in the receiving order R_{f} (the failed electrode E_{f} serves as the emitting electrode) and normal (for example, the received signal S₁ to S₁₆ of the received signal group G_{f-p2} are shifted forward by p2), and then replace the received signal group G_{f-1} with the shifted received signal group G_{f-p2}.

While the disclosure has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An electrical impedance imaging sensing element, comprising:
a body having a plurality of openings; and
N electrodes each being embedded in the body and partially exposed from the corresponding opening;
wherein each of the N electrodes is braided by a plurality of conductive wires, and N is a positive integer greater than or equal to 1.

2. The electrical impedance imaging sensing element as claimed in claim 1, further comprising:
N electrode fasteners each combining the body with the corresponding electrode, and electrically connected with the corresponding electrode.

3. An electrical impedance imaging sensing system, comprising:
a signal processing device electrically coupled to the sensing element and configured to output an emission signal;
the sensing element as claimed in claim 1, wherein each of the N electrodes is configured to receive a received signal of the emission which passes through a to-be-measured body; and
a processor configured to:
determine whether a determined one of the N electrodes has failed according to a plurality of the received signal;
in response to failure of the determined one of the N electrodes, compensate for the received signal of a failed electrode of the N electrodes; and
generate an electrical impedance image pre-processing data according to a plurality of the received signal.

4. The electrical impedance imaging sensing system as claimed in claim 3, wherein the signal processing device is further configured to:
in the n^{th} receiving order, output the emission signal to the n^{th} electrode, wherein n is a positive integer between 1 and N;
wherein in the n^{th} receiving order, the N electrodes receive the n^{th} received signal group of the emission signal which passes through the to-be-measured body; the processor is further configured to:
determine whether the determined one of the N electrodes has failed according to the N received signal groups; and
compensate for the received signal group of the failed electrode in response to the failure of the determined one of the N electrodes.

5. The electrical impedance imaging sensing system as claimed in claim 4, wherein the processor is further configured to:
replace the f^{th} received signal group with the (f+1)^{th} received signal group in response to the failure of the f^{th} one of the N electrodes, wherein f is one of 1 to N.

6. The electrical impedance imaging sensing system as claimed in claim 3, wherein the signal processing device is further configured to:
in the n^{th} receiving order, output the emission signal to the n^{th} electrode, wherein the (n−1)^{th} electrode is a grounding electrode, and n is a positive integer between 1 and N;
wherein in the n^{th} receiving order, the N electrodes receive the n^{th} received signal group;
wherein the processor is further configured to:
determine whether the determined one of the N electrodes has failed according to the N received signal groups; and
compensate for the received signal group of the failed electrode in response to the failure of the determined one of the N electrodes.

7. The electrical impedance imaging sensing system as claimed in claim 6, wherein the processor is further configured to:
replace the (f−1)^{th} received signal group with the (f−2)^{th} received signal group in response to the failure of the f^{th} of the N electrodes, wherein f is one of 1 to N.

8. The electrical impedance imaging sensing system as claimed in claim 4, wherein the processor is further configured to:
in response to the failure of the f^{th} electrode of the N electrodes, for the (f+1)^{th} received signal group, replace the received signal received by the m^{th} electrode with the received signal received by the (m+1)^{th} electrode, and replace the received signal received by the N^{th} electrode with the received signal received by the 1^{th} electrode, wherein f is one of 1 to N, and m is a positive integer between 1 to N; and
replace the f^{th} received signal group with the (f+1)^{th} received signal group.

9. The electrical impedance imaging sensing system as claimed in claim 4, wherein the processor is further configured to:
in response to the failure of the f^{th} electrode of the N electrodes, for the (f−2)^{th} received signal group, replace the received signal received by the m^{th} electrode with the received signal received by the (m−1)^{th} electrode, and replace the received signal received by the 1^{st} electrode with the received signal received by the N^{th} electrode, wherein f is one of 1 to N, and m is a positive integer between 1 to N; and
replace the (f−1)^{th} received signal group with the (f−2)^{th} received signal group.

10. An electrical impedance imaging sensing method, comprising:
outputting an emission signal to the sensing element as claimed in claim 1 by the signal processing device;
receiving a received signal of the emission signal which passes through the to-be-measured body by each of the N electrodes of the sensing element;
determining whether a determination one of the N electrodes has failed according to a plurality of the received signal by a processor; and
in response to failure of the determined one of the N electrodes, compensating for the received signal of a failed electrode of the N electrodes;
generating an electrical impedance image pre-processing data according to the a plurality of the received signal by the processor.

11. The electrical impedance imaging sensing method as claimed in claim 10, further comprising:
in the n^{th} receiving order, outputting the emission signal to the n^{th} electrode, wherein n is a positive integer between 1 and N;
in the n^{th} receiving order, receiving the n^{th} received signal group of the emission signal which passes through the to-be-measured body by the N electrodes;
determining whether the determined one of the N electrodes has failed according to the N received signal groups; and
compensating for the received signal group of the failed electrode in response to the failure of the determined one of the N electrodes.

12. The electrical impedance imaging sensing method as claimed in claim 11, further comprising:
replacing the f^{th} received signal group with the (f+1)^{th} received signal group in response to the failure of the f^{th} one of the N electrodes, wherein f is one of 1 to N.

13. The electrical impedance imaging sensing method as claimed in claim 10, further comprising:
in the n^{th} receiving order, outputting the emission signal to the n^{th} electrode, wherein the (n−1)^{th} electrode is a grounding electrode, and n is a positive integer between 1 and N;
in the n^{th} receiving order, receiving the n^{th} received signal group of the emission signal which passes through the to-be-measured body by the N electrodes;
determining whether the determined one of the N electrodes has failed according to the N received signal groups by the processor; and
compensating for the received signal group of the failed electrode in response to the failure of the determined one of the N electrodes.

14. The electrical impedance imaging sensing method as claimed in claim 13, further comprising:
replacing the (f−1)^{th} received signal group with the (f−2)^{th} received signal group in response to the failure of the f^{th} of the N electrodes, wherein f is one of 1 to N.

15. The electrical impedance imaging sensing method as claimed in claim 11, further comprising:
in response to the failure of the f^{th} electrode of the N electrodes, for the (f+1)^{th} received signal group, replacing the received signal received by the m^{th} electrode with the received signal received by the (m+1)^{th} electrode, and replace the received signal received by the N^{th} electrode with the received signal received by the 1^{th} electrode, wherein f is one of 1 to N, and m is a positive integer between 1 to N; and
replacing the f^{th} received signal group with the (f+1)^{th} received signal group.

16. The electrical impedance imaging sensing method as claimed in claim 11, further comprising:
response to the failure of the f^{th} electrode of the N electrodes, for the (f−2)^{th} received signal group, replacing the received signal received by the m^{th} electrode with the received signal received by the (m−1)^{th} electrode, and replacing the received signal received by the 1^{st} electrode with the received signal received by the N^{th} electrode, wherein f is one of 1 to N, and m is a positive integer between 1 to N; and
replacing the (f−1)^{th} received signal group with the (f−2)^{th} received signal group.
